(19) United States
(12) Patent Application Publication
(10) Pub. No.: US 2003/0089311 A1
(43) Pub. Date: May 15, 2003

(54) Pre-treatment tunnel and method of preparing extrusions or section bars for being powder or liquid coated

(76) Inventor: Silvio Trevisan, Verona (IT)

Correspondence Address: ORUM & ROTH, 53 W. JACKSON BLVD, CHICAGO, IL, 60604, US

(21) Appl. No.: 10/293,638

(22) Filed: Nov. 13, 2002

(30) Foreign Application Priority Data
Nov. 15, 2001 (IT) VR2001A000120

(51) Int. Cl. B05D 3/00

(52) U.S. Cl. 118/326; 427/444

(57) ABSTRACT

Pre-treatment tunnel and method of preparing extrusions or section bars for being coated, wherein each workpiece is caused to move along a pre-treatment path and each treatment liquid is poured from above onto each workpiece so as to spread liquid onto the entire external surface of each workpiece with no solution of continuity.

### BACKGROUND OF THE INVENTION

The present invention regards a pre-treatment tunnel and method of preparing extrusions or section bars, e.g. extruded aluminium bars or iron section bars, for a powder or liquid coating process.

As is known, at the current state of the art, powder or liquid coating of aluminium-alloy extrusions or iron section bars of considerable length is carried out in suitable automatic continuous treatment plants, in which the workpieces to be treated are moved in a horizontal direction while being suspended in a substantially vertical orientation or trim.

Normally, in such treatment plants a treatment process is carried out which comprises the following sequence of operation steps:

hanging the bars in a vertical trim on a chain or chains of a constantly moving overhead chain conveyor at a distance (pitch) between successive bars that varies depending upon the speed of movement of the overhead chain conveyor and the overall dimensions of the workpiece being treated;

pre-treating of the workpieces in a tunnel, where various treatment cycles are carried out in accordance with testing standards which may include, e.g. degreasing, a first washing, deoxidisation, a second washing, chromatizing, a third washing, a fourth or final washing with demineralized water;

drying, normally by means of hot air ventilation;

powder or liquid coating in a suitable booth or booths;

final backing, normally by means of hot air ventilation; and

unloading of the coated workpieces.

In any case, pre-treatment according to one of its numerous variants in the tunnel is required in order to obtain optimum preparation of the metal surfaces for receiving and permanently holding the coating material thereon, so that a uniform and aesthetically attractive coating is obtained which is waterproof in time.

Actual pre-treatment steps (except washings) carried out in the tunnel involve the use of highly corrosive liquids, which must be kept mostly within preset temperature ranges for predetermined exposure time intervals to obtain optimum results.

Overall pre-treatment action is thus obtained through proper combination of the following parameters: exposure time, temperature, degree of corrosiveness of the liquids and amount of recycled liquid poured onto the surface being treated.

The most used types of pre-treatment are the following.

a) Static Dipping System

This is the oldest system. Pre-treatment liquids are kept almost in a static condition and thus the wetted surface of the workpiece does not come in contact with new liquid, which means that chemical degreasing or detergent action is limited and long exposure times and/or high concentrations of corrosive products are thus required.

b) Dipping System with Oscillatory Movement of the Workpieces

This dipping system is slightly more effective than the previous one since the workpiece movement, although to a limited extent, promotes renewal of the liquid that comes into contact with the surface of the workpieces. From a practical point of view, this system leads to results that are more or less equivalent to those achievable with the previous system.

c) Spraying System with Flight Manifolds and Nozzles

This is the most common system currently in use because it makes it possible to feed the workpieces and promotes almost continuous change of the liquid wetting the workpiece surface.

The latter system, however, has limitations and drawbacks that will be illustrated with reference to FIGS. 1 and 2 of the accompanying drawings, in which:

FIG. 1 shows a diagrammatic front sectional view of a pre-treatment spraying plant with flight manifolds and nozzles,

FIG. 1a is a diagram showing the amount of liquid flowing down along a workpiece, whereas

FIG. 2 shows a top view of the plant shown in FIG. 1.

With reference to a pre-treatment tunnel as shown in the above listed Figures, it will be easily noted that each jet G from each of the nozzles U supported by the lateral flight manifolds R affects only a section or length portion of a workpiece P. For this reason, workpieces P do not come in contact with the same amount of sprayed liquid. The amount of liquid running down along each workpiece P being fed throughout the spraying stage increases from top downwards, e.g. as shown in the diagram (amount of liquid A/height B) in FIG. 1a.

Thus, each workpiece P is better treated at its lower portion than at its upper portion.

It has already been suggested that this problem can partly be solved by distributing the nozzles U at a non-uniform distance from each other, i.e. a shorter distance at the upper portion and a longer one at its lower portion so as to better balance the distribution of sprayed liquid. This expedient, however, complicates the design and assembling of the tunnel, while still holding that the various sections of the workpieces P in any case will not undergo the action of the same amount of sprayed liquid.

With reference to FIG. 2, it will be noted that the workpieces P are fed in the direction indicated by an arrow F substantially parallel to the two flight manifolds of nozzles R and thus are not evenly sprayed with liquid by the various jets G while moving through the treatment plant. More particularly, a workpiece P₁ is exposed to the jets G, normally of a splayed type, and is thus subjected to a thrust which it is difficult to contrast or balance. At the same time, a workpiece P₂ is not at all sprayed by jets G, whereas workpiece P₃ is in a similar condition to that of workpiece P₁, and so on.

In the areas between two contiguous jets G, such as that in which workpiece P₂ is located, the sprays G along the entire height of the manifolds R have very little effect on the workpiece since on one hand they collide with and neutralize each other, and on the other by being located at the edges of the range of action of their respective nozzle their action is far weaker and less effective and thus they promote more formation of mist or vapour rather than having some effect on the workpiece P₂ in transit. Accordingly, the workpieces P are effectively treated only at two opposite series of nozzles U (sections P₁, P₃ P₅ . . . ), whereas at their intermediate sections (P₂, P₄ . . . ) they are treated to a much lesser extent or not at all treated.

This circumstance, which is bound to the design of a spray tunnel with nozzles on fixed manifolds, is responsible for transverse swinging and collisions of the workpieces P, which, in turn, frequently results in the workpieces P tending to rotate about their own axis in a random manner and to swing (pendulum effect) in the feeding direction or in a direction normal to it with frequent collisions, entanglements up to the point in which adjacent workpieces are superimposed on each other, and gluing together phenomena between two or more workpieces P, especially when they have relatively large flat surfaces, with the consequence that two glued-together workpieces are treated at part only of their outer surface.

These phenomena often result also in workpieces P being disengaged and falling off in the treatment tunnel with consequent easily imaginable serious inconveniences, such as plant stoppage, removal of fallen workpieces, repair of plant components in case of damage, replacement of workpieces, and so on. It is therefore necessary that the plant be continuously supervised by operators to avoid production waste or at least reduce it to a minimum.

Another disadvantage of conventional pre-treatment tunnels consists in that the nozzles atomise the treatment liquid when producing jets G, which results in atomisation developing along the entire length of the workpiece P. This atomisation, especially in the hot sections of the pre-treatment tunnel, inevitably results in random sprays of liquid as well as clouds of mist and vapour being formed inside the pre-treatment tunnel, which inevitably causes treatment liquids to be transferred from one section of the tunnel to the other with consequent contamination of the treatment liquids.

Atomisation also promotes dispersion of the heat in the pre-treatment liquids which, at the very least, heats the walls (metal sheets) of the tunnel and the environment to no purpose rather than maintaining the detergent at the temperature required by the pre-treatment liquids themselves. This results in significant heat losses with consequent elevated running costs for the pre-treatment plant. Furthermore, the vapours produced by the atomisation are usually polluting for the environment, and must be collected and purified before disposal. Obviously, the supplementary equipment required for separating and/or purifying the atomised drops contribute to further increased plant and running costs.

### SUMMARY OF THE INVENTION

The main object of the present invention is to provide a pre-treatment method of, and tunnel for preparing metal workpieces for powder or liquid coating process, suitable for eliminating or drastically reducing the above-mentioned disadvantages which are inherent in conventional pre-treatment systems.

More particularly, the present invention aims to provide a method and a tunnel for pre-treating metal workpieces which, in comparison to the best pre-treatment systems available at the present state of the art, attain the following advantages:

maximum pre-treatment quality at the same exposure times and plant length,

significantly reduced production, installation and running costs,

elimination of uncontrolled movements of the workpieces during treatment,

drastic reduction of the problem of transfer of vapours from one section of the tunnel to another, with consequent elimination of the problems linked to mutual contamination of the pre-treatment liquids,

reduction of the running energy costs linked to heat dispersion in the heated zones of the tunnel; and

maximum reduction of the problems linked to extraction of polluting vapours.

According to a first aspect of the present invention, there is provided a pre-treatment method of preparing metal workpieces for a coating process, which includes feeding each workpiece along a pre-treatment path and is characterized in that each treatment liquid is poured uninterruptedly onto each workpiece from above in such a way as to cover the entire external surface of each workpiece.

The following results are attained as an immediate consequence of the above recited method:

each workpiece is covered by the same amount of liquid in an almost uniform manner from its top to its bottom,

the amount of liquid poured onto the moving workpiece covers its entire surface, including its interior surface in case of tubular parts,

the refreshment of the liquid on the surface of each workpiece is very high inasmuch as the liquid runs continuously along each workpiece.

These results constitute a decisive improvement in the efficiency of the degreasing-detergent-washing effect of the liquid, its exposure time or flow rate being the same. Furthermore, the action of each liquid on the workpiece is uninterrupted also in the feed direction of the workpiece itself, since each moving workpiece receives the same quantity of liquid starting from its entry into the pre-treatment path to its exit therefrom.

The solution proposed by the present invention thus eliminates all problems connected with splashing characteristic of a conventional spray pre-treatment system.

Any lateral thrust on the workpiece is also eliminated, so that the workpieces do not move in an uncontrolled or anomalous manner during their passage through the pre-treatment path and thus the workpieces do not swing, do not collide with each other, do not rotate around their own axes, do not get stuck together nor fall off the overhead conveyor.

Thanks to continuous flowing of a relatively large quantity of liquid vertically along each workpiece, atomisation of the liquid is reduced to a minimum resulting only to a minimum extent and only starting from the moment in which the liquid drips off the bottom of the workpiece into an underlying collection tank. This is a very important feature which eliminates in practice any overflow contamination, drastically reduces heat losses and does away with the need to install expensive separation systems (e.g. partition walls and the like), and extraction and external disposal systems for vapours and fumes.

According to another aspect of the present invention, there is provided a pre-treatment tunnel for carrying out the above described method, the said tunnel including a pre-treatment path for workpieces to be treated, a conveyor extending all along the length of the pre-treatment path and is designed to convey in sequence workpieces suspended therefrom, characterised in that at the tops of the workpieces conveyed by the conveyor a pre-treatment liquid delivering means is provided arranged to continuously supplying pre-treatment liquid which, either by overflowing from or exiting from suitable slits, covers each workpiece and flows down along it from the top to the bottom also by a percolating action, at least one liquid collection tank for the pre-treatment liquid discharged from each workpiece, and a filtering and recycling system for the liquid collected in each collection tank.

Advantageously, the pre-treatment path is delimited by a tunnel structure.

If desired, the conveyor can follow a tortuous path which makes it possible notably to reduce the overall length of the pre-treatment tunnel in comparison to that of conventional pre-treatment tunnels.

### BRIEF DESCRIPTION OF THE DRAWINGS

Further aspects and advantages of the present invention will be better apparent from the following detailed description of a preferred embodiment thereof given by way of illustrative and non-limiting example, the description being made with reference to FIGS. 3 to 5 of the accompanying drawings, in which:

FIG. 3 is a diagrammatic front elevation view of a pre-treatment tunnel according to the present invention;

FIG. 4 is a diagrammatic side elevation view of the tunnel of FIG. 3; and

FIG. 5 is a diagrammatic plane view of the tunnel of FIG. 4.

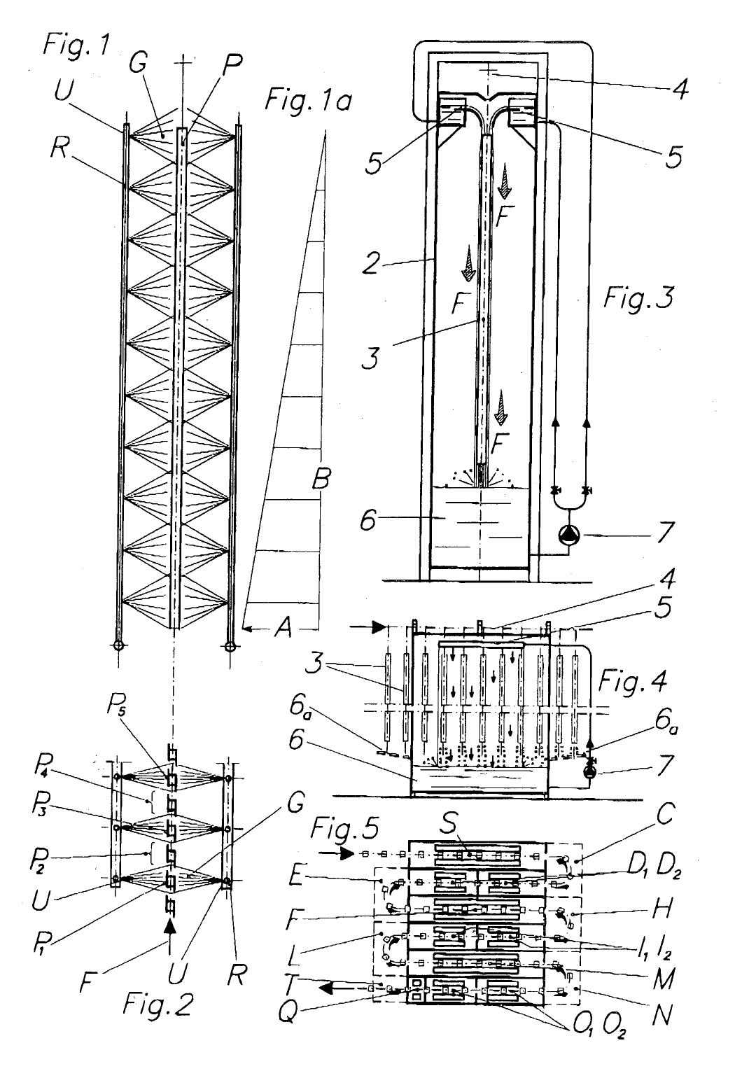

In FIGS. 3 to 5 identical or similar parts or components have been indicated with the same reference numerals.

### DESCRIPTION OF THE PREFERRED EMBODIMENTS

FIGS. 3 and 4 show a pre-treatment tunnel 1 for carrying out the method according to the present invention, in which one or more tunnel pre-treatment paths 2 are delimited for the workpieces 3 to be pre-treated. An overhead conveyor 4 extends along the entire pre-treatment path 2 and is designed to convey in sequence workpieces 3 suspended from it.

At the tops of the workpieces 3 conveyed by the conveyor 4 are installed two parallel channels 5 arranged to continuously supply, by overflow or exit from suitable slits, pre-treatment liquid at the top of each workpiece 3 conveyed by the conveyor 4. The liquid falling onto the workpiece 3 covers the workpiece itself and runs down it from its top to its bottom, as shown by arrows F in FIG. 3.

At the base of the tunnel 2 there is provided a tank 6 or sequence of tanks 6 for the collection of the pre-treatment liquid discharged from each pre-treated workpiece. A filtering and recycling circuit designed to filter and re-circulate the liquid from each collection tank 6 includes one or more pumps 7, whose delivery is connected to channels 5 for re-cycling the pre-treatment liquid.

FIG. 5 shows a plane view of an embodiment, in which several parallel sections of tunnel 2 are provided, one outwards and one returning, each of which is designated for a specific pre-treatment operation, while in the curved sections in which the direction of transport is inverted, outside the tunnel sections, the liquid dripping operations take place. More particularly, section S is dedicated to degreasing, curved return section C serves to allow the liquid to drip off the workpieces before the next pre-treatment liquid is applied. In the two straight sections D₁ and D₂ two successive washes are effected, followed by a section E in which the liquid is allowed to drip off the workpieces before entry into the deoxidising tunnel F. This is followed by an inversion and dripping curved H followed by two successive washing sections I₁ and. I₂ followed by another dripping section L before entry into a chromatizing tunnel M. On exiting the chromatizing tunnel M the workpiece is allowed to drip off in section N followed by two washes O₁ and O₂ and a wash with demineralized water in section Q and final dripping off in section T.

The embodiment of tunnel described above has a number of important design advantages which, in turn, translate into considerable production cost savings and reduced overall dimensions compared to conventional spray tunnels.

Above all, it will be noted that the pre-treatment stages S, D₁, D₂, F, I₁, I₂, M, O₁, O₂, Q (FIG. 5) are all located in separate tunnels or chambers, while all dripping off zones or paths C, E, H, L, N, T for recovery of the liquid are equipped with underlying vessel 6a for the recovery of the liquid in the tank 6.

If it is then borne in mind that the side walls of the tunnels are made of materials chosen for their high resistance to chemical aggression (e.g. stainless steel) and hence themselves very expensive, the advantages of limiting the closed tunnel-like sections of the plant with intervening open dripping off sections will be very evident.

The fact that the plant has a more or less square in plane view with a highly compact layout, enables the implementation of a pre-treatment tunnel of enormously reduced size compared to that of a conventional spray tunnel. This results in significant space savings as well as reducing investment in plant.

The disclosure in Italian patent application no. VR2001A000120 from which priority is claimed is incorporated herein by reference.

1) A pre-treatment method of preparing metal workpieces for a coating process, which includes conveying each workpiece along a pre-treatment path, and is characterised in that pre-treatment liquid is poured onto each workpiece from above, in such a way that the liquid covers the entire external surface of each workpiece.

2) A method according to claim 1, wherein pouring of liquid from above takes place by overflow from at least one overhead container or channel.

3) A method according to claim 1, wherein pouring of liquid from above takes place by exit from at least one slit provided in at least one overhead container or channel.

4) A method according to claim 1, wherein each pre-treatment liquid is re-circulated after discharge from a workpiece.

5) A pre-treatment tunnel for carrying out the method according to claim 1, comprising a pre-treatment path for workpieces, a conveyor means extending along the said pre-treatment path and designed to convey workpieces in sequence in a vertical orientation, supplying means at the tops of the said workpieces conveyed by the said conveyor means designed continuously to supply pre-treatment liquid that covers each workpiece and percolates from its top to its bottom, at least one collection tank for pre-treatment liquid discharged from each workpiece, and a recycling system designed to re-circulate liquid collected in each collection tank.

6) A tunnel according to claim 5, characterised in that the said pre-treatment liquid supplying means (5) supply liquid onto the workpieces by overflow.

7) A tunnel according to claim 4 or 5, characterised in that the said pre-treatment liquid supplying means (5) supply liquid onto the workpieces out of at least one slit.

8) A tunnel according to any claim 5 to 7, characterised in that the said pretreatment path is tortuous.

9) A tunnel according to claim 8, characterised in that the said pre-treatment path includes a number of pre-treatment stages (S, D₁, D₂, F, I₁, I₂, M, O₁, O₂ Q) arranged in separate tunnels or chambers, with intervening areas or paths of dripping off of the pre-treatment liquid (C, E, H, L, N, T) in which the liquid is recovered.

10) A tunnel according to claim 9, characterised in that it includes at least one collection tank or container (6) underneath the said pre-treatment stages (S, D₁, D₂, F, I₁, I₂, M, O₁, O₂, Q) and a vessel (6a) for collecting the discharged liquid in each dripping off zone (C, E, H, L, N, T).
